(19) United States
(12) Patent Application Publication
(10) Pub. No.: US 2010/0104862 A1
(43) Pub. Date: Apr. 29, 2010

(54) Adhesive Compositions for Hydrophobic Photopolymers

(75) Inventor: Alan Gene Miller, Austin, TX (US)

Correspondence Address: Giorgos A. Georgakis;Chowdhury & Georgakis, PC, PO BOX 90277, AUSTIN, TX, 78709-0277, US

(73) Assignee: ZEBRA IMAGING, INC., Austin, TX (US)

(21) Appl. No.: 12/260,080

(22) Filed: Oct. 28, 2008

(51) Int. Cl. B32B 27/00; C08L 69/00; C08K 3/10

(52) U.S. Cl. 428/339; 524/537; 524/413

(57) ABSTRACT

An adhesive composition is disclosed that includes an inorganic material and an adhesion promoting material where the weight ratio of the adhesion promoting material to the inorganic material is sufficient to permit adhesion of the adhesive composition to a hydrophobic photopolymer at or above a predefined adhesion strength level and to maintain an imaging quality of the hydrophobic photopolymer at or above a predefined minimum imaging quality level. The adhesive composition may be used as a tie layer in multilayer structures. In particular, the adhesive composition may be used as a tie layer for binding a hydrophobic photopolymer film to a low-birefringent cover sheet.

### I. BACKGROUND

The invention relates generally to adhesive compositions and more specifically to adhesive compositions that are useful as tie layers for hydrophobic photopolymers.

### II. SUMMARY

In one respect, disclosed is an adhesive composition comprising an inorganic material and an adhesion promoting material, wherein the weight ratio of the adhesion promoting material to the inorganic material is sufficient to permit adhesion of the adhesive composition to a hydrophobic photopolymer at or above a predefined adhesion strength level and to maintain an imaging quality of the hydrophobic photopolymer at or above a predefined minimum imaging quality level.

In another respect, disclosed is an adhesive composition comprising an inorganic material and an adhesion promoting material comprising at least one polar component and at least one non-polar component, wherein the weight ratio of the at least one non-polar component to the at least one polar component is between 1:5 and 4:1, and wherein the weight ratio of the adhesion promoting material to the inorganic material is less than or equal to about one.

In yet another respect, disclosed is a multilayer structure comprising a tie layer, wherein the tie layer has a first surface and a second surface and wherein the tie layer comprises an adhesive composition comprising an inorganic material and an adhesion promoting material, wherein the weight ratio of the adhesion promoting material to the inorganic material is sufficient to permit adhesion of the adhesive composition to a hydrophobic photopolymer at or above a predefined adhesion strength level and to prevent degradation of the imaging quality of the hydrophobic photopolymer beyond a predefined minimum imaging quality level.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1A is a cross-sectional representation of a multilayer structure in accordance with some embodiments.

FIG. 1B is a cross-sectional representation of a multilayer structure in accordance with some embodiments.

FIG. 1C is a cross-sectional representation of a multilayer structure in accordance with some embodiments.

FIG. 2 is a schematic representation of a system for fabricating a multilayer structure in accordance with some embodiments.

FIG. 3 is a schematic representation of a system for generating a holographic image using a multilayer holographic film in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. Upon reading this disclosure, many alternative embodiments of the present invention will be apparent to persons of ordinary skill in the art.

As used herein, the following definitions apply to the terms defined below unless otherwise expressly indicated in particular instances.

As used herein, the terms “including” and “comprising,” or any other variations thereof, are intended to be interpreted as non-exclusively including the elements or limitations which follow those terms.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

All percentages, ratios, and the like used herein are by weight unless otherwise expressly indicated in particular instances.

In addition, the ranges set forth herein include their endpoints unless expressly stated otherwise. Further, when an amount, concentration, or other value or parameter is given as a range or a list of upper values and lower values, this is to be understood as specifically disclosing all ranges formed from any pair of any upper range limit and any lower range limit, regardless of whether such pairs are separately disclosed.

An adhesive composition is disclosed herein that is capable of strongly adhering to a hydrophobic photopolymer without significantly degrading the imaging quality of the hydrophobic photopolymer. The adhesive composition is a composition that includes an inorganic material and an adhesion promoting material. In some embodiments, the adhesive composition may consist essentially of an inorganic material and an adhesion promoting material.

Photopolymers are light-sensitive polymer compositions whose physical properties change when exposed to light, which is generally in the visible or ultraviolet spectrum. Photopolymer compositions include relatively large amounts of active components in a polymer medium in which the active components can readily migrate. The active components may include various monomers and photosensitive dyes.

Photopolymers have many potential applications, including 3D printing, micro-optics, high-resolution lithography, and holographic imaging. Holograms may be generated using a variety of methods, including constructive and destructive interference of object and reference laser beams entering opposite sides of a film made of a photopolymer composition. This interference results in light and dark areas within the photopolymer, with photopolymerization occurring in only the former areas. Photopolymerization typically results in an area of different refractive index than that of the surrounding areas, thus producing an overall phase grating.

Many photopolymer compositions that are useful in applications such as holographic imaging tend to be more hydrophobic than hydrophilic, reflecting the nature of the active components and polymer media that make up the photopolymer. This is due in part to the ready availability of suitable component materials that have a large range of reactivities in photopolymerization reactions. For example, most monomers such as acrylates, methacrylates, vinyl acetates, vinyl ethers, styrenes and the like are more soluble in media, or blends of media, such as ketones, ethers, chlorinated hydrocarbons, alcohols and the like, rather than water. Water soluble forms are far less common. Similarly, many other polymer systems tend more to the hydrophobic side, for example polyacrylates, polymethacrylates, polyvinyl acetates, polyurethanes, polyesters, and the like. In addition, holograms produced from more hydrophobic materials are less sensitive to problems associated with humidity, for example tack and wavelength shifts due to swelling and de-swelling. As used herein, if a material is described as hydrophobic, it means that the material is primarily hydrophobic, unless otherwise expressly indicated in particular instances. Correspondingly, if a material is described as hydrophilic, it means that the material is primarily hydrophilic, unless otherwise expressly indicated in particular instances. As used herein, a material is primarily hydrophilic if its solubility is greater in water than other solvents and primarily hydrophobic if it is less soluble in water than in other solvents. Suitable photopolymers include OmniDex® films manufactured by DuPont, including OmniDex® 801.

A photopolymer may be characterized by an imaging quality, which is generally a measure of the ability of the photopolymer film to produce images that meet or exceed a given quality threshold. For photopolymers that are useful for forming holographic images, the imaging quality may be measured in terms of diffraction efficiency (DE), which may be defined as the ratio of the power of the diffracted beam to the incident beam at the wavelength of maximum diffraction. Alternatively, the imaging quality of a photopolymer may be measured based on the relative quality or appearance of the images produced using the photopolymer, where the image appearance may range on a sliding scale from no image on the low end to very bright on the high end.

The imaging quality may also reflect the degree of reactivity retained by active components in a photopolymer as a function of time or various other factors that could tend to diminish such reactivity. For example, the imaging quality of a photopolymer may be decreased or degraded through a variety of mechanisms, including, diffusion of active components out of the photopolymer into a compatible material in contact with the photopolymer. Photopolymers generally include relatively large amounts of monomer materials and a medium in which those materials can easily migrate. As a result, photopolymers are typically quite soft and tacky, and films made of such compositions require some type of protective cover sheeting on both sides of the films. Protective cover sheets made of birefringent polymer materials are typically used as they show a high resistance to penetration by active components of the photopolymer. Protective cover sheets made of low-birefringent polymer materials are generally not suitable because such materials offer low resistance to diffusion of active components out of the photopolymer. This diffusion may occur quickly since the photopolymer film can be very thin in comparison to the low-birefringent cover sheet.

Inorganic materials suitable for use in the adhesive composition include titanium, zirconium, and silica salts, and organometallic complexes, as well as combinations of any of the foregoing. In some embodiments, the inorganic material may include a cross-linking agent. In some embodiments, the cross-linking agent may be reactive with carboxyl groups and/or hydroxyl groups. Examples of suitable inorganic materials include titanium chelates, such as those sold under the name Tyzor® by DuPont, including dihydroxy-bis(ammonium lactato) titanium(IV), CAS:65104-06-5 (Tyzor LA), diisopropyl di-triethanolamino titanate, CAS: 36673-16-2 (Tyzor TE), and zirconium salts sold, for example, by MEI Chemicals, including potassium zirconium carbonate, CAS: 23570-56-1 (Zirmel 1000) and ammonium zirconium carbonate, CAS: 68309-95-5 (Bacote 20).

Suitable adhesion promoting materials include polymer compositions that are sufficiently compatible with the inorganic material and that are capable of bonding with hydrophobic photopolymers. Adhesion promoting materials may include polymer compositions of the type generally used to form tie layers for binding hydrophobic materials to hydrophilic materials. The adhesion promoting material includes polymeric components having polar and non-polar components. These components may be contained within the same copolymer or may be incorporated by blending homopolymers, copolymers, or combinations thereof.

The relative percentages of non-polar components to polar components may be selected to achieve a desired degree of compatibility of the adhesion promoting material with the inorganic material as well as to determine the strength of bonding to the hydrophobic photopolymers. In general, a higher relative amount of non-polar components will increase the strength of bonding. However, a higher relative amount of non-polar components will also facilitate the diffusion of active components out of the photopolymer, thereby decreasing the imaging quality of the photopolymer. In some embodiments, the ratio of non-polar components to polar components is between 1:5 and 4:1.

In some embodiments, the adhesion promoting material includes at least one polymeric component of molecular weight greater than 200 that is primarily polar due to containing one or more functional groups that are selected from the group including substituted and unsubstituted hydroxyl, amino, alkylamino, amido, sulfonic acid, carboxylic acid and salts thereof, where the substituents may be selected from alkyl groups having from 1 to 4 carbons, cyano, and halogen. Such functional groups may form part of the polymer backbone or may be attached as substituents to the polymer backbone. In some embodiments, the adhesion promoting material includes at least one polymeric component of molecular weight greater than 200 that is primarily non-polar due to containing one or more functional groups that are selected from the group including substituted or unsubstituted esters, ethers, ketones, sulfones, sulfonamides, urethanes, alkyl, vinyl and aryl groups, where the substituents may be selected from alkyl groups having from 1 to 4 carbons, cyano and halogen. As in the case above, such functional groups may form part of the polymer backbone or may be attached as substituents to the polymer backbone.

In some embodiments, the adhesion promoting material may include copolymers of vinyl pyrrolidone and vinyl acetate. Suitable examples of such copolymers include those sold commercially by International Specialty Products, Inc. under the names Copolymers 735, 600, 535, and 335. In some embodiments, the adhesion promoting material may consist essentially of copolymers of vinyl pyrrolidone and vinyl acetate.

The relative amounts of the inorganic material and adhesion promoting material included in the adhesive composition may be selected to simultaneously permit strong adhesion to hydrophobic photopolymers and maintain acceptable imaging quality of the hydrophobic photopolymers. Acceptable imaging quality may be defined as maintaining the imaging quality at or above a predefined minimum imaging quality level. In cases where the hydrophobic photopolymer is a holographic film, the minimum imaging quality may be defined in terms of diffraction efficiency or relative image appearance. Strong adhesion may be defined as the strength of the adhesion of a photopolymer to the adhesive composition equaling or exceeding a predefined adhesion strength level. The strength of adhesion should be maintained after any imaging, curing, or similar processes that the photopolymer may undergo. Increasing the amount of adhesion promoting material relative to the inorganic material will increase the strength of adhesion. The adhesive composition will not have sufficient strength of adhesion if the adhesive promoting material is excluded from the composition. However, a higher proportion of adhesion promoting material will also facilitate the diffusion of active components out of the photopolymer, thereby degrading or decreasing the imaging quality of the photopolymer. Some degradation of the imaging quality may be permitted so long as the imaging quality remains at or above the minimum imaging quality level.

The adhesion strength level and minimum imaging quality level may be determined based on the application. For example, in cases where a hydrophobic photopolymer film is used to produce high-resolution images, the minimum imaging quality level will be chosen to be higher than in applications where low-resolution images are adequate. In some embodiments, the adhesive composition may be used as a tie layer for binding a photopolymer film to a low-birefringent backing to form a holographic film that is capable of being roll-fed into a holographic printer. In this case, the adhesion strength level should be sufficient to permit the holographic film to be rolled up without separation of the photopolymer film, even after imaging, curing, and baking.

In general, the ratio of adhesion promoting material to inorganic material will be greater than zero and less than or equal to one. In some embodiments, the ratio of adhesion promoting material to inorganic material may range from 1:49 to 1:1. In some embodiments, the range may be 1:9 to 1:3.

The adhesive composition disclosed herein may be used as a tie layer in multilayer structures, such as multilayer films and sheets. For example, in some embodiments, the multilayer structure may be a multilayer holographic film. Due to the nature of the hydrophobic photopolymer compositions typically used in holographic films, such films are generally sandwiched between protective cover sheets. The protective cover sheets are typically composed of birefringent materials that inhibit diffusion of active components out of the photopolymer. One type of material that is commonly used for making birefringent cover sheets is polyethylene terephthalate (PET). Examples of a PET protective cover sheets include the Mylar® brand of films manufactured by DuPont Teijin Films. For example, Dupont's OmniDex 801 film is generally sandwiched between two protective Mylar cover sheets.

Holographic images may be formed using such holographic films by removing at least one of the protective cover sheets. Birefringence diminishes the quality of the holographic images made using the photopolymer film by rotating and scrambling the polarization of the laser beams used to produce the interference pattern giving rise to the image, which reduces diffraction efficiency and increases scatter. The birefringent effects of one protective cover sheet may be minimized by aligning the polarization of the laser beam used to form the interference patterns with the polarization of the protective cover sheet. The exposed surface of the photopolymer film may be laminated to a sheet of glass using the natural tackiness of the photopolymer. After standard laser exposure to generate the holographic grating, the film is UV cured and baked to generate the final hologram. Curing and baking decreases the tack of the photopolymer film, allowing the film to be removed from the glass. The processed film may then be laminated onto a backing material that is appropriate for displaying the holographic image. Removal of the protective cover sheet and subsequent lamination to the glass sheet require darkroom conditions, clean room conditions, a laminator, as well as a skilled technician to perform such operations. Additionally, the mechanical stresses to the sensitive photopolymer layer that may be introduced during the glass lamination and de-lamination steps tend to decrease imaging quality. The holographic film may be imaged using a holographic printer. In order to make larger size (e.g., A1 or A2) holograms that may be useful in applications such as mapping, advertising, and architecture, the printer will have to be large enough to accommodate the large sheets of glass that must be used.

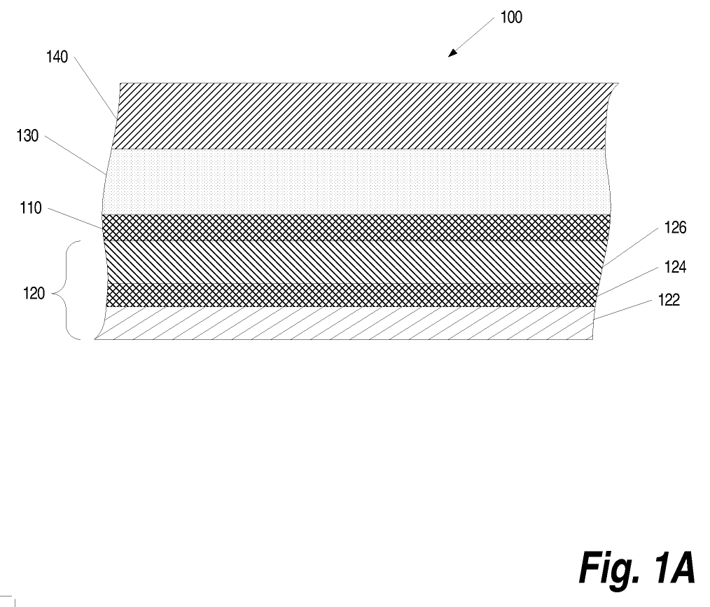

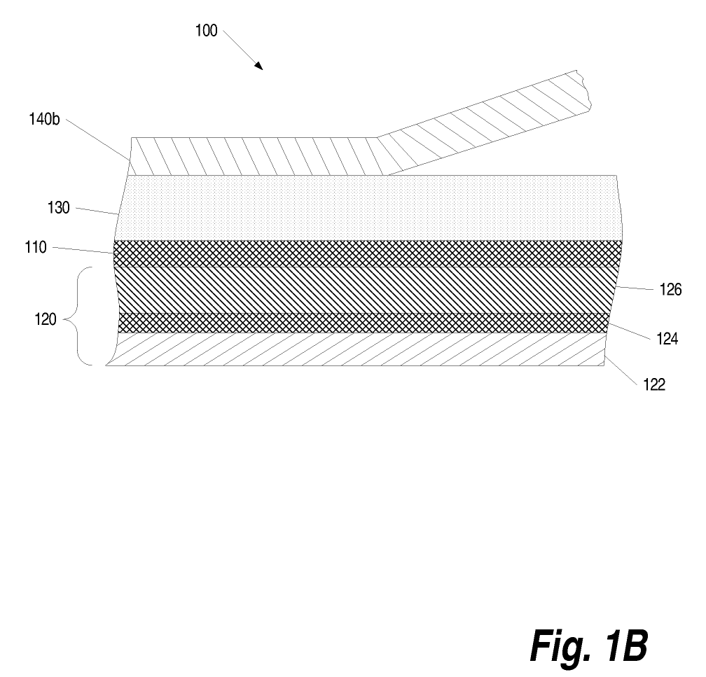

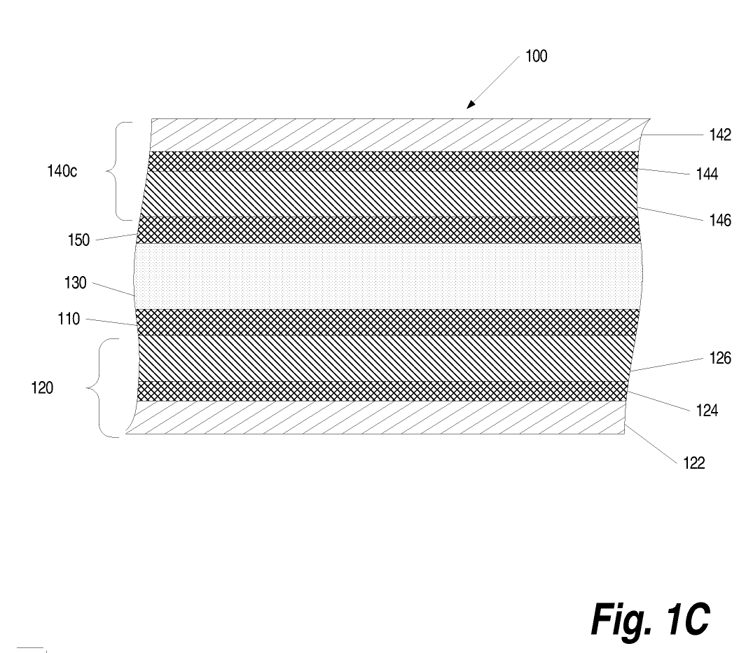

FIGS. 1A through 1C show cross-sectional representations of a multilayer structure in accordance with some embodiments. In FIG. 1A, multilayer structure 100 includes tie layer 110, which is shown disposed between cover sheet 120 and photopolymer layer 130. A lower surface of tie layer 110 adheres to an upper surface of cover sheet 120, and an upper surface of tie layer 110 adheres to a lower surface of photopolymer layer 130, thereby binding photopolymer layer 130 to cover sheet 120. Tie layer 110 is composed of the adhesive composition described above. In some embodiments, tie layer 110 may have a thickness that is less than or equal to about 10 microns. In some embodiments, tie layer 110 may have a thickness between about 0.2 and 2 microns.

Photopolymer layer 130 may generally include any hydrophobic photopolymer composition. In some embodiments, photopolymer layer 130 may be a holographic film, such as Dupont's OmniDex 801 holographic film.

Cover sheet 120 may include one or more layers. For the embodiment illustrated in FIG. 1A, cover sheet 120 includes backing layer 122, optional tie layer 124, and barrier layer 126. Backing layer 122 may include one or more layers that may be composed of one or more transparent materials. In some embodiments, the material comprising backing layer 122 may exhibit low-birefringence. In some embodiments, the material comprising backing layer 122 may also have sufficient flexibility to be wound into a roll form. In some embodiments, the material comprising backing layer 122 may also have sufficient durability to serve as a protective cover sheet for protecting underlying layers. Suitable materials for backing layer 122 include polycarbonate films such as Lexan® T2FOQ film manufactured by SABIC Innovative Plastics and Pure Ace® films manufactured by Teijin.

Barrier layer 126 may be employed to inhibit diffusion of active components out of photopolymer layer 130 into backing layer 122. Barrier layer 126 is generally composed of one or more hydrophilic polymer materials. Suitable polymer materials include polyvinyl alcohol, polyvinyl pyrrolidone, hydroxyethylcellulose, gelatins, carboxymethylcellulose, methyl cellulose ethers, starches, polyoxazolines, polyacrylic acids, co-polymers of polyvinyl alcohol and acrylic acid, co-polymers of vinyl pyrrolidone and vinyl acetate, and co-polymers of vinyl pyrrolidone and hydroxyl and amino functionalized acrylates. In some embodiments, barrier layer 126 may include a polyvinyl alcohol having a hydrolysis level of 70 to 88%. An example of a suitable hydrophilic polymer material for barrier layer 126 is Celvol® 603 manufactured by Celanese Corporation. In some embodiments, the thickness of barrier layer 126 may be from 1 to 100 microns. In some embodiments, the thickness of barrier layer 126 may be from 1 to 25 microns.

Due to the hydrophilic nature of barrier layer 126 and the hydrophobic nature of backing layer 122, direct adhesion of these layers may be difficult to achieve. To promote adhesion between the barrier and backing layers, one or more tie layers, such as optional tie layer 124 depicted in FIG. 1A, may be used. Alternatively, adhesion may be enhanced by surface treatment of the backing layer using techniques known to those skilled in the art, such as corona discharge. In some embodiments, surface treatment of the backing layer may be combined with use of tie layers to achieve a desired level of adhesion between the barrier layer and the backing layer.

Optional tie layer 124 may include polymer compositions of the type generally used to form tie layers for binding hydrophobic materials to hydrophilic materials. Various additives such as low molecular weight oligomers or inorganic materials such as alumina or silica sols may also be included. Suitable polymer compositions include polar and non-polar components. Typical polar components may include hydroxyl, alkoxy, amino, alkylamino, amido, sulfonic acid carboxylic acid groups, as well as sulfonate, carboxylate and amine salts. Typical non-polar components may include esters, ketones, alkyl groups, chlorinated alkyl groups and the like. These components may be contained within the same copolymer or may be incorporated by blending homopolymers, copolymers, or combinations thereof. Suitable examples of polymer compositions for optional tie layer 124 include copolymers of vinyl pyrrolidone and vinyl acetate, such as those sold commercially by International Specialty Products, Inc. under the names Copolymers 735, 600, 535, and 335. In some embodiments, the polymer compositions used to form optional tie layer 124 may include copolymers of vinyl pyrrolidone and vinyl acetate blended with copolymers of ethylene and acrylic acid.

Returning to FIG. 1A, cover sheet 140 is shown attached to an upper surface of photopolymer layer 130. Cover sheet 140 may include one or more layers. Various exemplary configurations of cover sheet 140 are illustrated in FIGS. 1B and 1C. Unless otherwise noted below, elements depicted in FIGS. 1B and 1C have similar properties to identically numbered elements in FIG. 1A.

FIG. 1B illustrates that cover sheet 140b may be removably attached to photopolymer layer 130 in multilayer structure 100. For example, in the case where photopolymer layer 130 is a holographic film, cover sheet 140b may be a protective cover sheet made of a birefringent material such as PET. As noted above, use of a single birefringent protective cover sheet is possible if the polarization of the laser beam is aligned with the polarization of the birefringent protective cover sheet. Thus, cover sheet 140b may be retained during imaging and subsequently removed. This also means that darkroom and clean room conditions are not necessary since the holographic film does not need to be laminated onto glass prior to imaging.

FIG. 1C illustrates that cover sheet 140c may be permanently adhered to photopolymer layer 130 in multilayer structure 100. Cover sheet 140c includes backing layer 142, optional tie layer 144, and barrier layer 146, which may have similar characteristics and properties as backing layer 122, optional tie layer 124, and barrier layer 126, respectively, as discussed above in reference to FIG. 1A. An upper surface of tie layer 150 adheres to a lower surface of barrier layer 146, and a lower surface of tie layer 150 adheres to an upper surface of photopolymer layer 130, thereby binding photopolymer layer 130 to cover sheet 140c. Tie layer 150 is composed of the adhesive composition disclosed herein.

One or more of the layers comprising the multilayer structures illustrated in FIGS. 1A-1C may be formed using conventional coating methods, where a liquid solution containing the layer material is applied and dried onto an adjacent layer. Coating methods may be used in combination with other methods such as lamination. In some embodiments, photopolymer layer 130 may be formed separately and subsequently laminated onto an intermediate structure that includes tie layer 110 and cover sheet 120. Once formed, the multilayer structures may be wound into rolls and stored until needed.

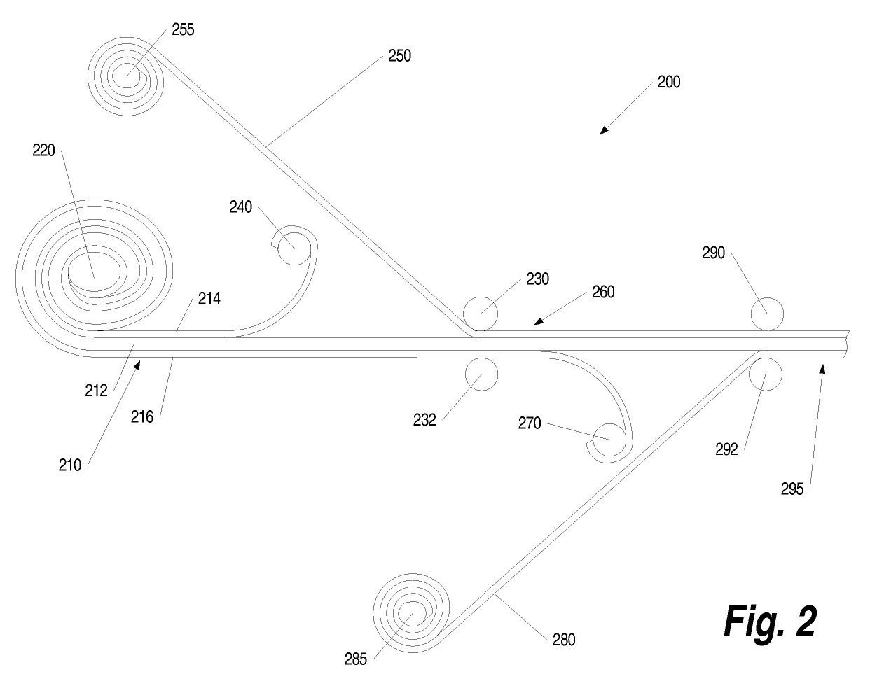

FIG. 2 is a schematic representation of a system for fabricating a multilayer structure in accordance with some embodiments. System 200 includes photopolymer film 210, which may include photopolymer layer 212 sandwiched between protective cover sheets 214 and 216. In some embodiments, photopolymer film 210 may be holographic film, and protective cover sheets 214 and 216 may be removable birefringent protective cover sheets. Photopolymer film 210 is supplied by supply roll 220. Prior to entering a lamination nip between opposing pinch rollers 230 and 232, protective cover sheet 214 may be peeled from photopolymer film 210 to expose the upper surface of photopolymer layer 212. The peeled protective cover sheet may be wound around take-up roll 240. Cover sheet 250 is supplied by supply roll 255. In some embodiments, covers sheet 250 may be the same as cover sheet 140c as shown in FIG. 1C. Lamination of cover sheet 250 to photopolymer film 212 requires use of a tie layer formed from the adhesive composition disclosed herein. In some embodiments, the tie layer may be formed onto cover sheet 250 prior to being wound around supply roll 255. In some embodiments, the tie layer may be applied to cover sheet 250 between being dispensed from supply roller 255 and prior to entering the lamination nip between pinch rollers 230 and 232. Cover sheet 250 may be laminated onto photopolymer layer 212 by the application of pressure between pinch rollers 230 and 232, resulting in photopolymer film 260. Heat may also be applied to facilitate lamination. Subsequently, protective cover sheet 216 may be peeled from photopolymer film 260 to expose the lower surface of photopolymer layer 212. The peeled protective cover sheet may be wound around take-up roll 270. Cover sheet 280 is supplied by supply roll 285. In some embodiments, covers sheet 280 may be the same as cover sheet 120 as shown in FIG. 1A. Lamination of cover sheet 280 to photopolymer film 212 requires use of a tie layer formed from the adhesive composition disclosed herein. In some embodiments, the tie layer may be formed onto cover sheet 280 prior to being wound around supply roll 285. In some embodiments, the tie layer may be applied to cover sheet 280 between being dispensed from supply roller 285 and prior to entering a lamination nip between pinch rollers 290 and 292. Cover sheet 280 may be laminated onto photopolymer layer 212 by the application of pressure between pinch rollers 290 and 292, resulting in photopolymer film 295. Photopolymer film 295 may subsequently be wound into a roll and stored until needed.

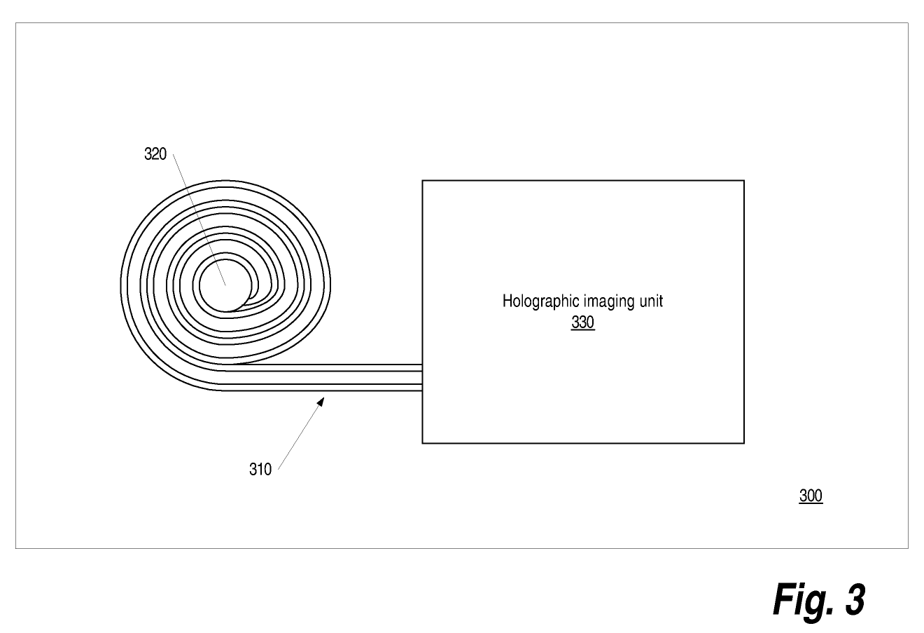

FIG. 3 is a schematic representation of a system for generating a holographic image using a multilayer holographic film, in accordance with some embodiments. System 300 includes holographic film 310 wound around supply roll 320. Holographic film 310 is a multilayer film of the type described with respect to FIGS. 1A-C above. Holographic imaging unit 330 is configured to receive holographic film 310 supplied by supply roll 320. Holographic imaging unit 330 is operable to generate holographic images within holographic film 310. The maximum width of holographic images generated via system 300 is constrained by the physical width of the system. However, the length of such images is not similarly limited due to the roll-feed nature of holographic film 310 and the fact that removal of a protective cover sheet is not required prior to imaging.

The following examples are provided to describe aspects of the adhesive composition disclosed herein in further detail. These examples are intended to be illustrative and not limiting.

### EXAMPLES

### Example 1

Onto sheets of Lexan® HP92HDP polycarbonate, 15 mil thick (available from SABIC), was coated 30% solids solutions of Copolymer I335, Copolymer I735, Celvol 603, and a 9:1 blend of Norlund Gelatin:Copolymer 1735, with a #4 Mayer bar. The sheets were dried for 1.25 minutes at 125° C. Onto the coated sheets and onto an uncoated sheet was laminated DuPont OmniDex 801 holographic film under red light conditions. A one centimeter square hologram was produced on one half of each sheet with a 532 nm YAG laser, using 12 mJ/cm energy in a 45° reflection-mode geometry configuration. The second half of each sheet underwent accelerated aging by storing for 3 hours in a dark, 55° C. oven. The same imaging process was used on the aged films. After UV treatment for 80 seconds using four Sylvania F15T8/350BL 15 watt bulbs, the Mylar protective sheets were removed from the photopolymer and the samples were baked at 125° C. for one hour, which generated the final holographic images. Table 1 summarizes the results.

TABLE 1

| | | Adhesion of | |
|---|---|---|---|
| | Relative | Film to | Aged Samples: |
| | Hydrophilicity of | Photopolymer | Image |
| Film Coating | Coating | after UV | Appearance |
| Bare | Mostly Hydrophobic | Excellent | No Image |
| Polycarbonate | 1 | | |
| I335 | 2 | Excellent | Trace Image |
| I735 | 3 | Fair | Moderately |
| | | | Bright |
| 9:1 Gelatin:I735 | 4 | Very Poor | Bright |
| Celvol 603 | 5 | Very Poor | Very Bright |
| | Mostly Hydrophilic | | |

This example demonstrates how the shelf life of a hydrophobic photopolymer film can be dramatically decreased when aged directly in contact with a polymer film having minimal crystallinity. The polymer film used was birefringent due to stresses created during the extrusion process by which PET protective cover sheets were manufactured. This also shows how the effectiveness of a barrier layer is directly dependent upon its hydrophilicity. This example also illustrates the difficulty of adhesion between the hydrophobic photopolymer and the hydrophilic barrier layer.

### Example 2

Onto 3 sheets of 15 mil Lexan® HP92HDP polycarbonate was coated a 30% solids solution of Copolymer I735 with a #4 Mayer rod and the films were dried for 80 seconds at 125° C. Both sheets were coated with a 15.6% solids solution of Celvol 603 with a #22 Mayer rod and the films were dried at 125° C. for 3 minutes. Onto one was coated a 30% solution of a 1:1 blend of Celvol 603 and Copolymer I335 and onto the second was coated a 7:3 blend of Celvol 603 and Copolymer I335; both with a #4 Mayer rod and both dried for 80 seconds at 125° C. DuPont OmniDex 801 photopolymer film was laminated to both; the samples were imaged and processed as above. Results are shown in Table 2.

TABLE 2

| | Diffraction | |
|---|---|---|
| | Efficiency | |
| Surface Coating in Contact | (Average | Adhesion of Photopolymer |
| with Photopolymer | of 6 Gratings) | to Coated Polycarbonate |
| 1:1 Celvol 603:Copolymer | 53% | Acceptable |
| I335 | | |
| 7:3 Celvol 603:Copolymer | 75% | Very Poor |
| I335 | | |

This example demonstrates that when adhesion promoting materials are blended directly with the barrier layer, acceptable adhesion to the photopolymer can be obtained, but only with an unacceptable loss in the imaging quality of the photopolymer.

### Example 3

Onto 3 sheets of 15 mil Lexan® HP92HDP polycarbonate was coated a 30% solids solution of Copolymer I735 with a #4 Mayer rod and the films were dried for 80 seconds at 125° C. Both sheets were coated with a 10.0% solids solution of Celvol 523 with a #22 Mayer rod and the films were dried at 125° C. for 3 minutes. Onto one sheet was coated a 30% solution and onto a second a 10% solution of Copolymer I335, giving approximately 3 micron and 1 micron dry thicknesses respectively. Both were laminated with DuPont OmniDex 801 photopolymer film and imaged and processed as above. The results are shown in Table 3.

TABLE 3

| Surface Coating | | Adhesion |
|---|---|---|
| in Contact | Diffraction Efficiency | of Photopolymer |
| with Photopolymer | (Average of 6 Gratings) | to Coated Polycarbonate |
| 1 micron I335 | 48% | Poor |
| 2 micron I335 | 37% | Acceptable |

This example demonstrates that coating an adhesion promoting material by itself onto a barrier layer results in acceptable adhesion only at thicknesses where imaging quality becomes poor.

### Example 4

Onto a 100 micron Teijin Pure-Ace® polycarbonate film was coated a 30% solids solution of Copolymer I335 with a #22 Mayer rod and dried 3.5 minutes at 133° C. Onto this was coated a 31% solids solution of Celvol 603 with a #22 Mayer rod and dried 4 minutes at 133° C. Onto this was coated a 30% solids solution of 87:13 Tyzor® TE:Copolymer I335 in a solution with water to alcohol ratio of 0.8 with a #4 Mayer rod and it was dried for 1.5 minutes at 132° C. This gives approximately a one micron dry coating thickness. DuPont 801 OmniDex holographic film was laminated to this film and an identical sheet was laminated to glass. Both were imaged and processed as described and the results are shown in Table 4.

TABLE 4

| | | Adhesion Between |
|---|---|---|
| | | Photopolymer |
| | | and Contact |
| Surface in Contact with | Diffraction Efficiency | Surface after |
| Photopolymer | (Average of 6 Gratings) | UV Curing |
| Glass | 83% | None |
| 87:13 Tyzor TE:I335 | 82% | Acceptable |

This example shows that acceptable adhesion and imaging quality can be attained when the adhesion promoting material is incorporated into an inorganic material as a minor component. In addition, a durable surface is created, unlike the surfaces in Example 3.

### Example 5

Onto 3 sheets of 100 micron Teijin Pure-Ace® polycarbonate film was coated a 30% solids solution of 7:3 Michem® Prime 4983R (Michelman):Copolymer I335 with a #22 Mayer rod and dried 3.5 minutes at 130° C. Onto each of these sheets was coated a 31% solids solution of Celvol 603 and dried for 4 minutes at 130° C. The sheets were then coated with a 30% solids solution of 87:13 Tyzor® TE:Copolymer I335 in a solution with water to alcohol ratio of 0.8 with a #4 Mayer rod and dried for 1.5 minutes at 130° C.

Photopolymer film was laminated to the coated films and also to two sheets of uncoated film. A film of each type was kept at ambient while an identical set underwent accelerated aging in a 50° C. dark oven for 16 hours. The films were imaged side-by-side by refractive index matching the polycarbonate surfaces to glass and exposing them with a pulsed frequency doubled Nd:YAG laser at 532 nm, with reference and object beams at a 45 degree angle. Solid green refection holograms were produced by sequentially printing 1 mm² holographic images, side-by-side, each using a single 80 nsec pulse, where object and reference beams were 14 μJ at the film plane. Samples were UV cured for two minutes (˜400 mJ at 368 nm) and baked for 40 minutes at 115° C. Relative radiance values were measured with a SpectraScan® camera from PHOTO RESEARCH, Inc. Results are shown in Table 5.

TABLE 5

| | OmniDex 801 | OmniDex 801 on |
|---|---|---|
| | on Teijin | Coated Teijin |
| Ratio of Sample Radiances × 100 | Pure-Ace ® Film | Pure-Ace ® Film |
| Aged @50° C. for 16 hrs then | 0 | 100 |
| imaged | | |
| Kept ambient 16 hrs then imaged | | |

This example demonstrates that when the adhesion promoting material is incorporated within the inorganic material, the photopolymer not only retains its imaging quality, but this imaging quality can be retained after accelerated aging.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. An adhesive composition comprising an inorganic material and an adhesion promoting material, wherein the weight ratio of the adhesion promoting material to the inorganic material is sufficient to permit adhesion of the adhesive composition to a hydrophobic photopolymer at or above a predefined adhesion strength level and to maintain an imaging quality of the hydrophobic photopolymer at or above a predefined minimum imaging quality level.

2. The adhesive composition of claim 1, wherein the adhesion promoting material is capable of degrading the imaging quality of the hydrophobic photopolymer below the predefined minimum imaging quality level in the absence of the inorganic material.

3. The adhesive composition of claim 1, wherein the inorganic material provides insufficient adhesion to the hydrophobic photopolymer in the absence of the adhesion promoting material.

4. The adhesive composition of claim 1, wherein the adhesive composition is capable of strongly adhering to a hydrophilic material.

5. The adhesive composition of claim 1, wherein the adhesive composition is transparent.

6. The adhesive composition of claim 1, wherein the adhesion promoting material comprises at least one polar component and at least one non-polar component, wherein the weight ratio of non-polar components to polar components is between 1:5 and 4:1.

7. The adhesive composition of claim 1, wherein the adhesion promoting material comprises at least one polymeric component of molecular weight greater than 200 comprising one or more functional groups selected from the group comprising substituted and unsubstituted hydroxyl, amino, alkylamino, amido, sulfonic acid, carboxylic acid and salts thereof.

8. The adhesive composition of claim 1, wherein the adhesion promoting material comprises at least one polymeric component of molecular weight greater than 200 comprising one or more functional groups selected from the group comprising substituted and unsubstituted esters, ethers, ketones, sulfones, sulfonamides, urethanes, alkyl, vinyl and aryl groups.

9. The adhesive composition of claim 1, wherein the adhesion promoting material comprises a copolymer comprising at least one polar component and at least one non-polar component, wherein the weight ratio of non-polar components to polar components is between 1:5 and 4:1.

10. The adhesive composition of claim 1, wherein the weight ratio of the adhesion promoting material to the inorganic material is less than or equal to about one.

11. The adhesive composition of claim 1, wherein the inorganic material comprises a cross-linking agent.

12. The adhesive composition of claim 1, wherein the inorganic material is selected from the group consisting of titanium, zirconium and silica salts, and organometallic complexes.

13. An adhesive composition comprising an inorganic material and an adhesion promoting material comprising at least one polar component and at least one non-polar component, wherein the weight ratio of the at least one non-polar component to the at least one polar components is between 1:5 and 4:1, and wherein the weight ratio of the adhesion promoting material to the inorganic material is less than or equal to about one.

14. A multilayer structure comprising a tie layer, wherein the tie layer has a first surface and a second surface and wherein the tie layer comprises the adhesive composition of claim 1.

15. The multilayer structure of claim 14, wherein the tie layer has a thickness that is less than or equal to about 2 microns.

16. The multilayer structure of claim 14, further comprising a low-birefringent cover sheet adhered to the first surface of the tie layer.

17. The multilayer structure of claim 16, wherein the low-birefringent cover sheet comprises a hydrophilic barrier layer adhered to a hydrophobic backing layer and wherein the first surface of the tie layer is adhered to the hydrophilic barrier layer.

18. The multilayer structure of claim 16, further comprising a hydrophobic photopolymer layer adhered to the second surface of the tie layer.

19. The multilayer structure of claim 16, further comprising a second tie layer located between the hydrophilic barrier layer and the backing layer, wherein a first surface of the second tie layer adheres to the barrier layer and a second surface of the second tie layer is adhered to the backing layer.

20. The multilayer structure of claim 14, wherein the multilayer structure is a roll-fed film.
